(19) United States
(12) Patent Application Publication
(10) Pub. No.: US 2018/0178292 A1
(43) Pub. Date: Jun. 28, 2018

(54) Novel Methods of Metals Processing

(71) Applicant: Pioneer Astronautics, Lakewood, CO (US)

(72) Inventors: Mark Berggren, Golden, CO (US); Robert Zubrin, Golden, CO (US); Jonathan David Rasmussen, Denver, CO (US)

(73) Assignee: Pioneer Astronautics, Lakewood, CO (US)

(21) Appl. No.: 15/850,375

(22) Filed: Dec. 21, 2017

Related U.S. Application Data
(60) Provisional application No. 62/437,854, filed on Dec. 22, 2016.

(51) Int. Cl. B22F 9/22; C01B 33/025; C01B 33/06; C22B 5/12; C22B 26/22; B33Y 70/00; C25B 1/04

(52) U.S. Cl. CPC B22F 9/22; C01B 33/025; C01B 33/06; C22B 5/12; C22B 26/22; B22F 2301/35; C25B 1/04; B22F 2201/013; B22F 2201/04; B22F 2202/09; B22F 2301/058; B33Y 70/00

(57) ABSTRACT

Novel methods for the production of iron, silicon, and magnesium metal from extraterrestrial and terrestrial resources are described. The methods employ processing steps including metal oxide reduction using carbon monoxide, carbon, hydrogen, and methane. Methods to prepare, regenerate, and recycle reductants to minimize mining and purchase of fresh materials and to minimize carbon emissions are included.

### RELATED APPLICATIONS

This application claims the benefit of U.S. Provisional application No. 62/437,854 titled “Novel Methods of Metals Processing” filed Dec. 22, 2016 which is incorporated herein by reference.

### GOVERNMENT SUPPORT STATEMENT

This invention was made with Government support under a NASA JPL SBIR Phase I Contract NNX16CP31P and NASA JPL SBIR Phase II Contract NNX17CP08C. The Government has certain rights in this invention.

### BACKGROUND OF THE INVENTION

Advances in astronautics and space exploration have identified great potential and the need for efficient methods in extraterrestrial metals processing (EMP) to expand human exploration and colonization capabilities and to make useful materials for terrestrial purposes while substantially reducing the costs and risks of bringing supplies from Earth. EMP product streams will be highly useful for advanced casting or additive manufacturing methods to allow for efficient use of resources to enable endeavors in space exploration.

Developing novel methods for Extraterrestrial Metals Processing also leads to new applications and efficient means for terrestrial metals and materials production to address unmet and long felt needs in the art.

### SUMMARY OF THE INVENTION

The EMP technology includes novel methods for production of iron, silicon, and magnesium metals as well as refractory metal oxides and byproducts including phosphorus, sulfur, and oxygen from Mars, Moon, or asteroid in-situ resources for advanced human space exploration and from terrestrial resources for alternative Earth-based processing. The EMP product suite includes many useful materials that will expand space exploration and colonization capabilities while substantially reducing the costs and risks of bringing supplies from Earth. EMP is also useful for terrestrial technology to reduce carbon emissions and to enable use of alternate resources and process methods. Many EMP product streams are suitable for use in advanced casting or additive manufacturing methods to allow for efficient use of resources. One potential terrestrial EMP application is the production of metallic iron while regenerating and recycling the carbon-based reductant (carbon monoxide) from the carbon dioxide reaction product, thereby reducing or eliminating release of carbon to the atmosphere. In this application for metallic iron production, three main process steps are integrated. These steps consist of iron oxide reduction by carbon monoxide (producing metallic iron plus carbon dioxide), the reverse water gas shift reaction (producing carbon monoxide plus water from carbon dioxide plus hydrogen), and water electrolysis (producing hydrogen plus oxygen from water). With these steps operating in integrated fashion, iron oxide is the process input, and metallic iron plus oxygen are the process outputs. FIG. 1 illustrates one example of such processing. One skilled in the state-of-the-art can identify operating conditions (temperature, pressure, and CO/CO₂ ratio) for iron oxide reduction and the reverse water gas shift reaction leading to virtually complete reduction of iron oxides to metallic iron while controlling or eliminating the deposition of carbon onto the metallic iron product.

Another potential terrestrial application of EMP is the production of high-grade silicon metal or ferrosilicon. The hydrogen-enhanced carbon monoxide disproportionation method employed in the EMP system enables high rates of carbon deposition onto silica in the absence of a metal catalyst. Direct carbon deposition from CO generated during carbothermal reduction integrated with reverse water gas shift (RWGS)-electrolysis modules would reduce the purchase of carbon for the process while significantly reducing overall carbon emissions compared to current practice. The carbon deposited by this method would be of very high purity. Such processing would have particular application and potential for manufacturing cost savings if carbon emissions become regulated. In a complete closed-loop system including reverse water gas shift and electrolysis units, silicon or ferrosilicon manufacturing could be accomplished with virtually no carbon emissions. FIG. 2 illustrates one example of such processing. In this example, operating conditions are adjusted to create a controlled gas mixture from an RWGS module containing the proper range of hydrogen concentrations to enhance the rate of carbon deposition in the carbon deposition reactor.

Another potential terrestrial application of EMP is the production of magnesium metal via carbothermal reduction. A significant difficulty encountered during such reduction of magnesium oxide containing feeds with carbon is that the resulting metallic magnesium metal vapors readily react with the carbon monoxide byproduct to create magnesium oxide plus carbon, thus negating the intended reaction. The present invention overcomes this problem in part by performing the magnesium oxide reduction with carbon in vacuum. Metallic magnesium vapor produced by the reaction is ionized via radio frequency or other means. The ionized magnesium vapors are steered in one direction via a dipole magnet and are directed to a grounded, cooled plate where magnesium metal collects. Simultaneously, carbon monoxide vapors are directed to the inlet of a vacuum pump. Alternatively, or in conjuction with collection of ionized magnesium vapors, a cooled magnesium metal collection plate may also be incorporated. FIG. 3 illustrates one example of such processing.

The EMP techniques have additional potential for the processing of lower-grade ores and feed stocks including other process residues and wastes. As higher-grade ores on Earth are more-difficult to find and mine, feed costs for existing technologies rise. The EMP can help to reduce overall processing costs by enabling the use of non-conventional feed stocks.

### BRIEF DESCRIPTION OF DRAWINGS

FIG. 1. Block diagram for production of metallic iron.

FIG. 2. Block diagram for production of metals and metal oxides.

FIG. 3. Diagram for production of magnesium metal via carbothermal reduction.

FIG. 4. Block diagram for production of silicon-based products and oxygen byproduct.

FIG. 5. Block diagram for production of iron.

FIG. 6. Block diagram for production of magnesium via silicothermic reduction.

FIG. 7. Carbon conversion during carbothermal reduction experiments CT-01 through -04.

FIG. 8. Release of carbon monoxide and dioxide during CT-02 (1650° C. max).

FIG. 9. SEM/EDS spectrum of CT-02 slag phase.

FIG. 10. SEM/EDS spectrum of carbothermal reduction ferrosilicon beads.

FIG. 11. Carbon conversion during carbothermal reduction experiments Silica-01 through -03.

FIG. 12. EDS spectrum of Mg beads from experiment Mg-04.

FIG. 13. EDS spectrum of experiment Mg-08 magnesium crown product.

### DETAILED DESCRIPTION OF THE INVENTION

Processes for efficient production of iron, silicon, and magnesium metals as well as refractory metal oxides and byproducts including phosphorus, sulfur, and oxygen from terrestrial, Mars, Moon, or asteroid in-situ resources by novel means are described herein. The products are useful for manufacturing in support of terrestrial industry and advanced human space exploration. The EMP product suite includes many useful materials that will expand exploration and colonization capabilities while substantially reducing the costs and risks of bringing supplies from Earth. Many EMP methods and product streams are suitable for use in extraterrestrial and terrestrial advanced casting or additive manufacturing methods to allow for efficient use of resources. In one embodiment, a method for the production of metallic iron via carbon monoxide reduction in a closed-loop with reverse water gas shift and water electrolysis is provided. In another embodiment, a method for the production of metallic magnesium is provided. In one embodiment, a method for the production of high-grade silicon metal or ferrosilicon is provided. In one embodiment, a hydrogen-enhanced carbon monoxide disproportionation process is employed that enables high rates of carbon deposition either separately or directly onto pure silica in the absence of a metal catalyst. FIG. 4 illustrates an example of such processing using Mars resources. Similar methods may be applied to other resources on Mars, the Moon, asteroids, or Earth. On Earth, direct carbon deposition from CO generated during carbothermal reduction integrated with RWGS-electrolysis modules would reduce the purchase of carbon for the process while significantly reducing overall carbon emissions compared to current practice. The carbon deposited by this method would be of very high purity. Such processing would have particular application and potential for manufacturing cost savings if carbon emissions become regulated. In one embodiment, a process with a complete closed-loop system including a reverse water gas shift and electrolysis unit, silicon or ferrosilicon manufacturing has virtually no carbon emissions.

In other embodiments, the processes are used in processing of lower-grade ores and feed stocks including residues and wastes. As higher-grade ores are more-difficult to find and mine, feed costs for existing technologies rise, the novel processes claimed will reduce overall processing costs by enabling the use of non-conventional feed stocks. In one embodiment, iron-oxide bearing materials can be reduced to produce metallic iron using reductants such as hydrogen or carbon monoxide. Additionally, methane and carbon may also be used as reductants to reduce iron oxides to metallic form. In one embodiment, iron-oxide-rich deposits such as those known to exist on Mars may be used to produce high-grade iron. FIG. 5 illustrates one such example using Mars iron-oxide resources. Similar process methods may be applied to other iron-oxide resources available on Mars, the Moon, asteroids, or Earth.

In other embodiments reactions are employed to generate hydrogen, carbon monoxide, methane, and carbon reductants for metal oxide reduction. A summary of the reactions employed to generate hydrogen, carbon monoxide, methane, and carbon reductants for metal oxide reduction are shown in the following table. Reaction enthalpies are shown for 25° C. at standard state. Electrolysis provides complete conversion in a single pass. Methanation exhibits a very high equilibrium constant and a per-pass conversion in the 90 percent range.

The reverse water gas shift reaction exhibits a relatively low equilibrium constant under typical operating conditions and requires a gas separation/recycle system to produce nearly pure carbon monoxide. The Boudouard carbon deposition reaction exhibits a very high equilibrium constant, but reaction rate is limited by kinetics.

TABLE 1
Reductant Preparation Reactions.

| | | ΔH, |
|---|---|---|
| Re ductant Preparation Reaction | | kJ |
| Electrolysis (H₂ from H₂O) | H₂O₍ₗ₎ = H₂ + 0.5 O₂ | 285.8 |
| Reverse Water Gas Shift | CO₂ + H₂ = CO + H₂O₍ₗ₎ | −2.9 |
| (CO from CO₂) | | |
| Methanation (CH₄ from CO) | CO + 3 H₂ = CH₄ + H₂O₍ₗ₎ | −249.9 |
| Boudouard (C from CO) | 2 CO(g) = C + CO₂ | −172.4 |
| RWGS-Boudouard-Electrolysis | CO₂ = C + O₂ | 393.5 |
| (C from CO₂) | | |

The following table summarizes the overall candidate metal production reactions and shows some of the key properties and features of each reaction. Note that a significant mass of byproduct oxygen is generated by each of the candidate processes. Production of iron metal has the lowest energy input per unit mass of metal produced and has a significantly lower power requirement per unit rate of production. Iron also has the highest density of the candidate metals.

TABLE 2
Overall EMP Metal Reduction Reaction Summary.

| | | | | | Energy | Energy | Power Input, | Oxygen |
|---|---|---|---|---|---|---|---|---|
| | | | Metal | Metal | Input, | Input, | kW at | Yield, |
| | | ΔH, | Molecular | Density, | kJ/kg | kJ/L | 100 kg/day | kg/kg |
| Overall Reduction Reaction | | kJ | Weight | kg/L | Metal | Metal | Metal | Metal |
| Iron | Fe₂O₃ = 2 Fe + 1.5 O₂ | 823.0 | 55.85 | 7.85 | 7,368 | 57,842 | 8.5 | 0.43 |
| Silicon | SiO₂ = Si + O₂ | 910.9 | 28.09 | 2.33 | 32,432 | 75,501 | 37.5 | 1.14 |
| Magnesium | MgO = Mg + 0.5 O₂ | 601.6 | 24.31 | 1.74 | 24,752 | 43,019 | 28.6 | 0.66 |
| Aluminum | Al₂O₃ = 2 Al + 1.5 O₂ | 1675.7 | 26.98 | 2.71 | 31,053 | 84,215 | 35.9 | 0.89 |
| Titanium | TiO₂ = Ti + O₂ | 944.7 | 47.88 | 4.50 | 19,732 | 88,792 | 22.8 | 0.67 |

Iron oxide can be reduced using hydrogen and carbon monoxide. Additional potential iron oxide reduction techniques include the use of methane (such as employed on Earth for “direct reduction” processes) and carbon. The carbon monoxide reduction reaction is exothermic under the typical high-temperature conditions (700-900° C.) while the other reactions are mildly or significantly endothermic at high temperature. Regardless of the reduction approach, the overall iron oxide reduction reaction can be written as follows.

Fe₂O₃=2Fe+1.5O₂ ΔH=823.0 kJ (1)

For hydrogen reduction, the net reaction is obtained by electrolysis and hydrogen reduction by combining the following two reactions.

3H₂O=3H₂+1.5O₂ ΔH=857.4 kJ (2)

Fe₂O₃+3H₂=2Fe+3H₂O ΔH=−34.4 kJ (3)

The combined reactions (9) plus (10) yield the net overall reaction shown in (1).

For carbon monoxide reduction, the net reaction is obtained by the addition of the reverse water gas shift reaction, electrolysis, and carbon monoxide reduction as follows to obtain the net reaction in (1) above.

3CO₂+3H₂=3CO+3H₂O ΔH=−8.6 kJ (4)

3H₂O=3H₂+1.5O₂ ΔH=857.4 kJ (5)

Fe₂O₃+3CO=2 Fe+3CO₂ ΔH=−25.9 kJ (6)

Similar reactions are applied for reduction of other iron oxides including FeO and Fe₃O₄. For methane reduction, the net reaction is obtained by methanation, electrolysis, and methane reduction as follows to obtain the net reaction in (1) above.

3CO+9H₂=3CH₄+3H₂O ΔH=−749.7 kJ (7)

3H₂O=3H₂+1.5O₂ ΔH=857.4 kJ (8)

Fe₂O₃+3CH₄=2Fe+3CO+6H₂O ΔH=715.0 kJ (9)

For the carbothermal reduction of iron oxide, the net reaction is obtained by the reverse water gas shift reaction (10), the Boudouard carbon deposition reaction (11), electrolysis (12), and carbon reduction (13) as follows to obtain the net reaction in (1) above.

3CO₂+3H₂=3CO+3H₂O ΔH=−8.6 kJ (10)

6CO=3C+3CO₂ΔH=−517.3 kJ (11)

3H₂O=3H₂+1.5O₂ ΔH=857.4 kJ (12)

Fe₂O₃+3C=2Fe+3CO ΔH=491.4 kJ (13)

In one embodiment, the iron oxide reduction process is a hydrogen reduction method. In one embodiment, the iron oxide reduction processes is a carbon monoxide reduction method. In one embodiment, the reduction process is done with sufficiently fine iron oxide particles. Reduction followed by sintering can be performed at temperatures below the melting point of iron (1538° C.). Alternatively, the iron-rich product can be melted and refined to transport impurities such as phosphorus, sulfur, and silicon to a slag phase while adjusting carbon content and alloying agent compositions of the iron melt. Embodiments of the process are described in FIG. 5. Several variants to the flow sheet are possible to balance product quality with process complexity.

In other embodiments, metal oxide reductions are used in the process. In such cases, oxides of increasing reduction difficulty can be made by preparing a reductant from a metal oxide that is less difficult to reduce. For example, silicon metal can be prepared by reduction of silicon oxide using carbon. The silicon metal, which is generally considered a superior reductant for magnesium than carbon, can then be used to reduce magnesium oxide to metal form.

Silica-rich deposits containing as much as 91 weight percent SiO₂ were found by the Spirit rover on Mars (Squyres et al., 2008). Results from the Opportunity rover also suggested the presence of similar silica deposits, indicating wide-spread availability of this material. Carbothermal reduction is routinely carried out on Earth to produce silicon and ferrosilicon for metals refining and semi-conductor applications (after further refining and doping with small amounts of other metals such as phosphorus (potentially recoverable as a byproduct from Mars carbothermal reduction), boron, gallium, or arsenic.

Carbothermal reduction of Mars and lunar regolith has been identified as a method to produce high purity silicon compounds, ferrosilicon, carbides, and alkaline earth compounds that are fumed during reduction and condensed in cooler zones of the reactor system. In addition to the potential direct use of silicon (from silica-rich feeds) or ferrosilicon (from undifferentiated Mars or lunar soils), these materials enable the manufacture of metallic magnesium.

Carbon reductant is used to produce silicon according the following endothermic reaction.

SiO₂+2C=Si+2CO ΔH=689.8 kJ (14)

With iron oxide present in the feed, carbothermal reduction proceeds as follows.

Fe₂O₃+3C=2Fe+3CO ΔH=491.4 kJ (15)

Reaction (22) is shown for ferric iron as would be expected on Mars. On the Moon, a similar reaction occurs with ferrous iron as shown.

FeO+C=Fe+CO ΔH=156.8 kJ (16)

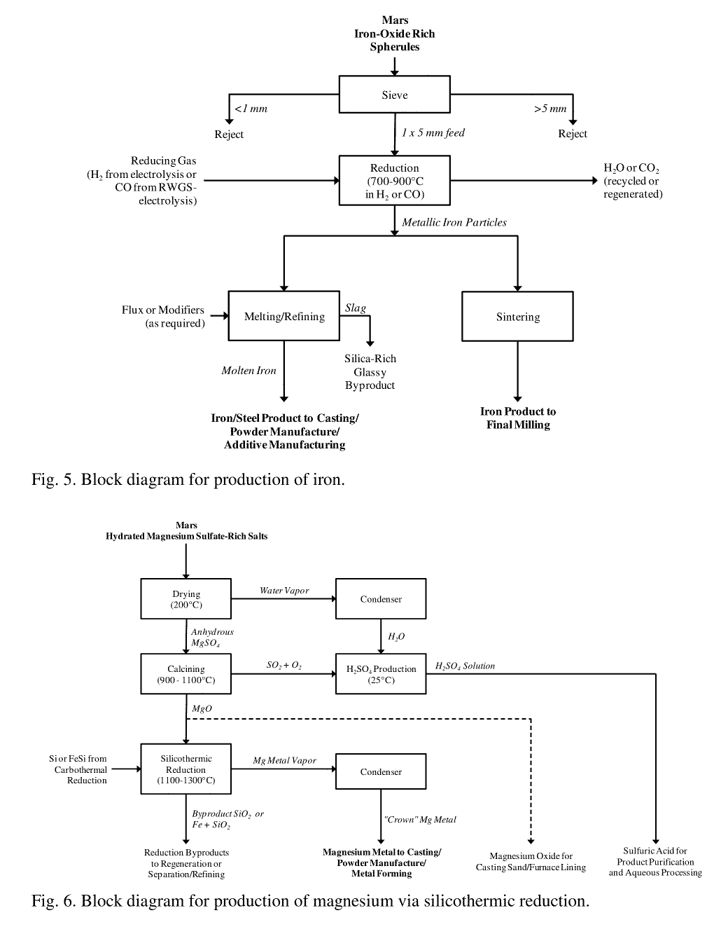

In any case, the reduced product after carbothermal reduction will contain ferrosilicon (or iron silicide) with Fe and Si in the approximate proportion to the feed composition. FIG. 6 illustrates one such process using magnesium sulfate deposits on Mars. Similar process methods can be applied using other resources available on Mars, the Moon, asteroids, or Earth.

In the case of a Mars application, carbon is obtained from CO₂ in the atmosphere. In a lunar application, carbon is either recovered from volatiles in the soil or is imported. In one embodiment, carbon is deposited directly onto lunar regolith simulant. The soil is exposed to operating conditions that both reduce the contained iron oxides to metallic iron and that deposit carbon via the Boudouard reaction as follows.

2CO=C+CO₂ ΔH=−172.4 kJ (17)

Experiments were carried out to obtain high per-pass yields of carbon from carbon monoxide using a hydrogen-enhanced carbon deposition technique in which reaction rates are significantly improved with addition of only about 2-3 percent H₂ to the CO feed gas. While internal reactions may take place to enhance carbon deposition in the presence of hydrogen, nearly all of the hydrogen is recovered in the carbon deposition reactor exhaust. In either case, carbon deposition is carried out in a combination of reverse water gas shift, Boudouard, and electrolysis reactions.

In one embodiment, when using silicon as a reductant for magnesium metal production, the silicon dioxide produced during magnesium production can potentially be recycled and regenerated to silicon metal using the flow sheet shown below in FIG. 5 and FIG. 6.

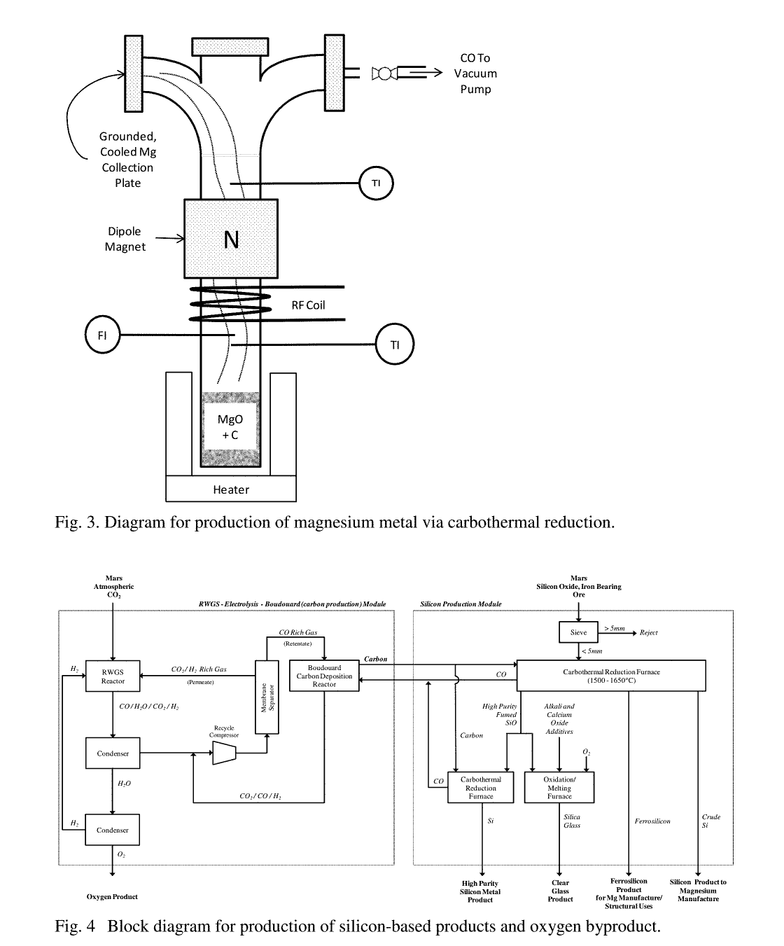

The reduction of magnesium oxide from terrestrial resources or from extraterrestrial resources such as magnesium sulfate (which is converted to magnesium oxide as shown in FIG. 6) via carbothermal reduction would substantially reduce process complexity (see FIG. 3). The present invention enables carbothermal reduction of magnesium oxide in part by performing the magnesium oxide reduction with carbon in vacuum. Metallic magnesium vapor produced by the reaction is ionized via radio frequency or other means. The ionized magnesium vapors are steered in one direction via a dipole magnet and are directed to a grounded, cooled plate where magnesium metal collects. Simultaneously, carbon monoxide vapors are directed to the inlet of a vacuum pump. Alternatively, or in conjuction with collection of ionized magnesium vapors, a cooled magnesium metal collection plate may also be incorporated. FIG. 3 illustrates one example of such processing.

Experimental—Iron Production in Closed Loop with Recycle of CO Reductant

The following experiment illustrates the production of metallic iron with concurrent recovery, regeneration, and recycle of the carbon-containing reducing agent. The process, as shown in FIG. 1, generates metallic iron product as well as oxygen. Iron oxides containing iron in the forms of +2 or +3 are collected from available resources on Earth, the Moon, Mars, or asteroids. At temperatures greater than 600 C, carbon monoxide is reacted with iron oxide to produce metallic iron and carbon dioxide. Because the conversion of iron oxides to metallic iron is not necessarily complete in a single pass, an excess of reductant gas is supplied via recirculation to ensure nearly complete reduction of iron oxides to metal. As iron oxides are reduced to metal, carbon dioxide is formed as shown in equation (6). A mixture of carbon monoxide and carbon dioxide exit the reduction reactor and are fed to a reverse water gas shift reactor. Hydrogen from electrolysis is introduced to the RWGS reactor to reduce carbon dioxide to carbon monoxide. The operation of the RWGS is adjusted so that the resulting gas (after removal of moisture) contains a mixture of CO and CO₂. The RWGS reaction shown in equation (4) has a relatively low equilibrium per-pass conversion of CO₂ to CO. Therefore, the RWGS product gas (after condensing and removing water) is directed to a membrane separator containing polysulfone or other suitable permeable membrane material that exhibits very high selectivity to passing CO₂ and H₂ compared to CO. The more-permeable gases such as CO₂ and H₂ report to the membrane separator permeate and are recycled to the RWGS reactor via a compressor. The non-permeating gas, richer in CO, reports to the retentate, which is then directed to the iron oxide reduction reactor. By adjusting parameters in the RWGS system, such as permeate recycle rate, the resulting retentate can be made to contain a controlled concentration of CO₂ along with CO. This feature allows for a reducing gas mixture containing predominately CO but with sufficient CO₂ to prevent deposition of carbon in the iron oxide reduction reactor. The iron oxide reduction reactor is integrated with the RWGS reactor system (including condenser, separation membrane, and recycle compressor) along with an electrolyzer (to convert water formed in the RWGS reactor to hydrogen (for recycle to the RWGS reactor) and oxygen (as a byproduct of the iron oxide reduction process). The result is a closed-loop system that converts iron oxide into metallic iron and oxygen.

### Experimental—Silicon Production

A high-temperature furnace was configured to carry out the carbothermal reduction of silica-containing feeds. A Micropyretics Heaters International Inc. (MHI) horizontal tube furnace (Model H18-40HT) was used for the experiments. The furnace is equipped with molybendum disilicide heater elements for operation at temperatures up to about 1750° C. A Eurotherm® 2416CP controller is used to provide programmable temperature ramp rates and over-temperature safety controls.

Samples were loaded into a Coorstek® mullite (aluminum silicate) furnace tube of about 42-inches (106.7-cm) length. Mullite was chosen for its high-temperature strength and thermal shock resistance. The cylindrical tube used for initial experiments was Coorstek item 66310 with an outside diameter of 1.50 inches (3.81 cm) and an inside diameter of 1.25 inches (3.18 cm). Later experiments were carried out in a similar Coorstek tube (item 66320) with an outside diameter of 1.625 inches (4.13 cm) and an inside diameter of 1.375 inches (3.49 cm) as well as in a larger-diameter mullite tube (item 66328) with an outside diameter of 2.75 inches (6.99 cm) and an inside diameter of 2.375 inches (6.03 cm).

The open-ended tubes were fitted with endplates manufactured from stainless steel with a Viton® seal to provide a gas-tight fit. The total 42-inch tube length allows for gradual heating and cooling outside the 12-inch (30.5 cm) active hot zone, which is at the center of the tube. Insulation was added to reduce the temperature profile along the length of the tube outside the hot zone while still cooling the endplates to roughly 95° C.

A high-temperature thermocouple was located in the hot-zone of the furnace. In addition, thermocouples were placed at various locations along tube approaching the exhaust endplate. Temperature data were logged using a LabJack® U6-Pro interface and DAQFactory® data acquisition and control software on a laptop computer.

The endplates have fittings to allow for feeding and withdrawing gases. The feed gas line includes a gas flow meter and a manometer. The manometer allows for measurement of system pressure and also serves as a relief valve in the event of pressures above about 15-inches water column (about 37 millibar gauge pressure) since the tubes are not rated for pressure/vacuum operation at elevated temperatures. The exhaust gas line was configured to be directed to a flow meter or sent directly to a vent.

Experiments were run to identify what compounds (in addition to carbon monoxide produced by carbothermal reduction) might be produced from JSC Mars-1 simulant. The simulant was first calcined at a temperature of 600° C. to dehydrate and burn out any potential organic carbon that may be present. An additional supply of JSC Mars-1A simulant (<1 mm particle size) was procured to supplement the effort.

Average Mars soil analyses from Viking and Pathfinder as well as JSC Mars-1 simulant used for testing has the following analysis. The analysis for simulant used during initial EMP experiments was determined by x-ray fluorescence (XRF) analysis on Pioneer's batch of simulant and compares well with that of NASA's analysis of similar material.

TABLE 3
Analysis of Mars Soils and Simulant.

| | Average, Normalized | | | | <20 Mesh, 600 C. Calcined | |
|---|---|---|---|---|---|---|
| | Viking and Pathfinder | | Normalized JSC Mars-1 | | JSC Mars-1 Simulant | |
| | Analyses | | Simulant Analysis (NASA) | | Analysis (XRF) | |
| Compound | As Oxide | As Element | As Oxide | As Element | As Oxide | As Element |
| Fe₂O₃ | 19.46 | 13.61 | 15.62 | 10.92 | 16.40 | 11.47 |
| MnO | n.a. | n.a. | 0.28 | 0.22 | 0.27 | 0.21 |
| MgO | 7.00 | 4.22 | 3.40 | 2.05 | 2.21 | 1.33 |
| CaO | 6.34 | 4.53 | 6.19 | 4.42 | 5.61 | 4.01 |
| Na₂O | 2.32 | 1.72 | 2.40 | 1.78 | 1.80 | 1.34 |
| K₂O | 0.22 | 0.18 | 0.61 | 0.51 | 0.70 | 0.58 |
| Al₂O₃ | 8.03 | 4.25 | 23.31 | 12.34 | 22.80 | 12.07 |
| SiO₂ | 47.91 | 22.40 | 43.50 | 20.33 | 42.90 | 20.05 |
| TiO₂ | 0.86 | 0.51 | 3.79 | 2.27 | 3.69 | 2.21 |
| SO₃ | 7.22 | 2.89 | n.a. | n.a. | <0.13 | <0.05 |
| Cl | 0.63 | 0.63 | n.a. | n.a. | <0.02 | <0.02 |
| P₂O₅ | n.a. | n.a. | 0.89 | 0.39 | 0.80 | 0.35 |
| TOTAL | 100.00 | 54.95 | 100.00 | 55.24 | 97.33 | 53.69 |

Undifferentiated soil simulant was chosen for preliminary carbothermal reduction experiments due to the availability of similar compositions at virtually all locations on Mars. However, many minerals containing high concentrations of iron oxide, magnesium salts, and silica are present in soils that are local or regional in nature.

Experiments were carried out to characterize the response of JSC Mars-1 and JSC-1A lunar regolith simulants as a function of temperature. A ratio of 0.165 g carbon per g feed soil was used for each of the first two experiments using JSC Mar-1 simulant, which is the approximate stoichiometric requirement to reduce the contained SiO₂. Because iron oxide was not pre-reduced, the added amount was slightly substoichiometric since some of the carbon (about 0.04 g carbon/g soil) would be consumed by iron oxide reduction. A higher ratio (with carbon in slight excess of stoichiometric) was used for the third experiment. The fourth experiment with JSC-1A lunar simulant used a carbon ratio of 0.159 (approximately stoichiometric). A heating rate of 15° C. per minute up to 600° C. followed by 10° C. per minute up to the final target temperature was used for all experiments. The hold time at maximum temperature was 2 hours in each case. During the first experiment (CT-01), four 5 ml alumina reaction boats (Coorstek 65562; 70 mm long, 14 mm wide, 10 mm high) were used. During the second experiment (CT-02), three 10 ml alumina reaction boats (Coorstek 65564; 90 mm long, 17 mm wide, 11.4 mm high) were used. A similar arrangement was used for experiments CT-03 and CT-04.

Carbon in the form of graphite (Aldrich 28,286-3; 1-2 microns; synthetic) was thoroughly mixed with calcined JSC Mars-1 simulant or as-received JSC-1A lunar simulant and loaded uniformly into the reaction boats. This material is similar to carbon produced via the Boudouard reaction during Pioneer Astronautics work related to carbon capture from spacecraft cabin air, which x-ray diffraction had indicated was over 90 percent graphite. The reaction boats were loaded into the mullite tube in a line centered in the furnace hot zone. A helium sweep gas flow of about 200 sccm was passed through the reactor system to both remove volatile reaction products and to act as a tracer gas to facilitate diagnosis of experimental results. The exhaust gas flow rate and gas composition were taken throughout the course of heat up, hold time at maximum temperature, and cool down. Gas analyses were performed using a four-channel Varian CP-4900® micro gas chromatograph (GC) capable of detecting and quantifying carbon monoxide and carbon dioxide as well as any hydrogen, oxygen, nitrogen, methane, and higher alkanes at concentrations near one ppm. Results showed virtually all of the gas in the exhaust consisted of carbon monoxide and carbon dioxide (along with the helium sweep gas).

The following table summarizes the test conditions and key results from carbothermal reduction of Mars and lunar soil simulants.

TABLE 4
Carbothermal Reduction Experiment Summary - Simulants.

| | Exp | Exp | Exp | Exp |
|---|---|---|---|---|
| Test Parameter | CT-01 | CT-02 | CT-03 | CT-04 |
| Simulant Type | JSC | JSC | JSC | JSC-1A |
| | Mars-1 | Mars-1 | Mars-1 | Lunar |
| Reduction Temperature, ° C. | 1550 | 1650 | 1650 | 1650 |
| Carbon:Soil Mass Ratio | 0.165 | 0.165 | 0.266 | 0.159 |
| Carbon Conversion to CO, % | 73.7 | 92.9 | 80.9 | 80.1 |
| Si Metal Yield, % of Feed Soil Mass | 9.1 | 12.1 | 18.7 | 10.9 |
| Oxygen Yield, % of Feed Soil Mass | 15.3 | 18.8 | 15.6 | 19.2 |
| Fumed SiO Product Yield, % of Feed Soil | 2.6 | 2.7 | 2.3 | 0.14 |

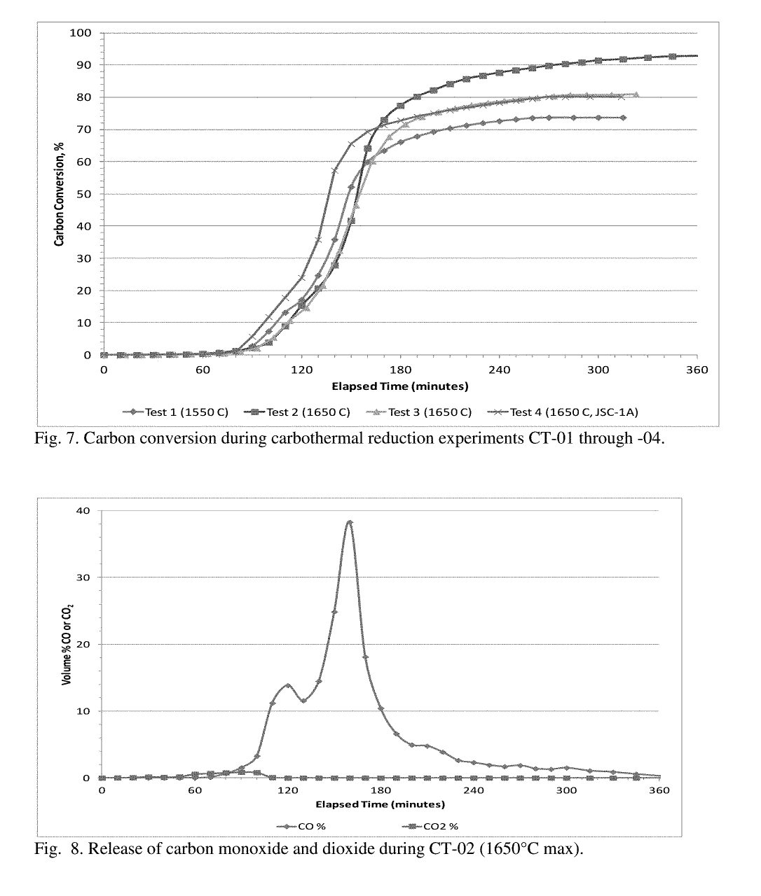

The higher carbothermal reduction temperature of 1650° C. used for experiments CT-02 through CT-04 resulted in greater carbon conversion to carbon monoxide (and correspondingly greater potential yield of contained oxygen). The higher carbon:soil ratio used during experiment CT-03 resulted in both lower carbon conversion to CO and lower overall oxygen yield. It is likely that the excess carbon resulted in the formation of carbides, which reduced the recovery of carbon as CO. It is possible that longer reaction times and/or higher temperatures would allow reaction of carbides formed during reduction to react with silica to generate silicon plus carbon monoxide. FIG. 7 shows the carbon conversion versus elapsed time and temperature for experiments CT-01 through CT-04.

FIG. 8 shows the concentrations of carbon monoxide and carbon dioxide in the carbothermal reduction experiment exhaust for Exp CT-02. Most of the carbon in the exhaust was in the form of carbon monoxide produced by carbothermal reduction of silicate minerals. The small amounts of carbon dioxide are thought to be mostly associated with the reduction of iron oxides. The initial release of carbon monoxide is at least in part also associated with reduction of iron oxides.

During the first two experiments, no internal condensers or traps were installed. Instead, observations of deposit locations were noted prior to recovering products. The temperature profile data collected during each experiment was evaluated to determine the approximate temperature at the locations where deposits were formed. Based on these observations, a 0.25-inch (0.63-cm) outside diameter cooling tube was inserted along the centerline of the reaction tube at a length of 8 inches (20.3 cm) from the exhaust end plate (replacing the internal thermocouple shown below during experiments CT-03 and CT-04). The cooling tube was cooled by injecting air through an internal tube that terminated near the cooling tube tip. Based on observations in the exhaust gas tubing, some fine particles or aerosols continued to travel past the endplate and into the exhaust tubing. This was evidenced by the deposits noted on the exhaust endplate and thermocouple after testing. The darker color of the endplate deposit following experiment CT-02 at 1650° C. may have resulted from release of sulfur deposited as elemental sulfur. The white deposits on the thermocouple are more likely silicon-rich compounds from SiO fuming.

The cooling tube installed after experiment CT-02 collected a small amount of white, apparently SiO deposits near its tip (at the hottest location along the cooling tube). However, deposits continued to be observed near the exhaust end plate and in exhaust tubing. Some of the silicon-rich product deposits quickly upon cooling (near the tip of the cooling tube), but significant additional fine material condenses on the end plate (and some continues to condense in the exhaust tubing or is carried to the exhaust tubing as fine particles). The yellow-color material condensed in the recess of the cooling tube fitting is likely sulfur. The results of the cooling tube experiments indicate that greater surface area and optimization of cooling temperatures could result in much more efficient collection of SiO.

The yields of fumed silicon-rich material recovered from deposits on the mullite tube walls were similar for each experiment. Analyses of products to verify their composition and impurity levels were determined from scanning electron microscope/energy dispersive x-ray spectroscopy (SEM/EDS), which indicated very high Si concentration.

The residues remaining in the alumina reaction boats were granular but otherwise uniform in appearance following carbothermal reduction at 1550° C. The residue from CT-02 at 1650° C. was more glassy overall, and the phases were more distinct in this high-temperature residue. The light-colored un-reduced calcium-aluminate rich fraction occurs along with smaller metallic-appearing beads (ferrosilicon) and darker material (possibly carbides). The residue was crushed, and attempts to recover ferrosilicon by magnetic separation were made. However, the material was found to be non-magnetic. Therefore, alternate separation methods to recover the bead-like ferrosilicon particles from the glassy slag are required. The vastly different physical characteristics allowed manual separations following liberation of the ferrosilicon beads from the slag by crushing. Automated physical separations based on differences in particle size, shape, or other properties should yield high separation efficiencies.

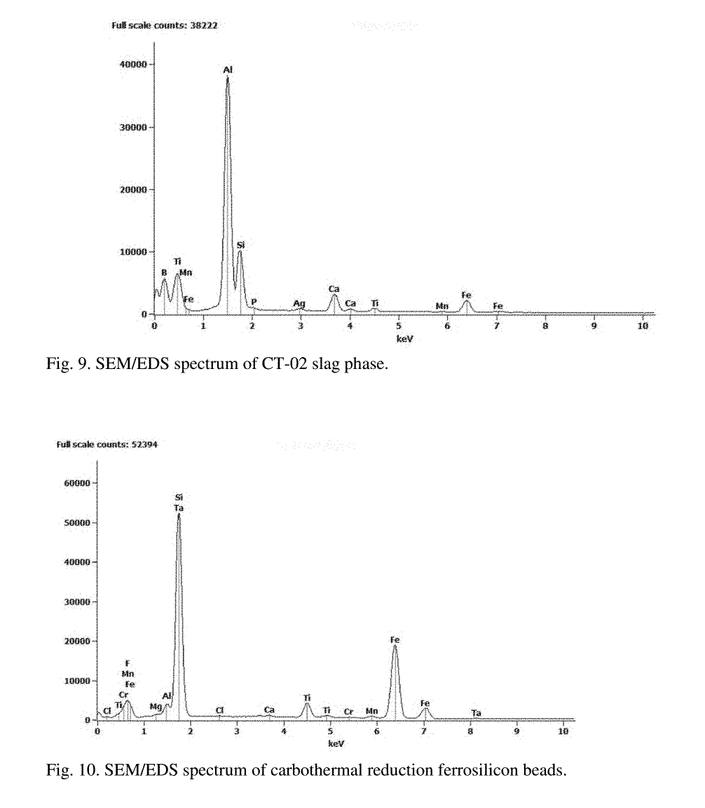

Manual separations of the material shown for CT-02 above yielded a glassy slag that was rich in aluminum, silicon (likely residual oxide) and smaller amounts of calcium and iron. FIG. 9 shows the SEM/EDS spectrum for the slag product.

Sharp separation of the carbothermal reduction solid phases is evident from the fact that iron is present in only small amounts in the glassy slag phase (see above spectrum) but is prevalent, along with silicon, in the metal beads separated from the slag. FIG. 10 shows the SEM/EDS spectrum of the ferrosilicon beads from carbothermal reduction.

Note that “escape peaks” can occur in the SEM/EDS analysis due to the nature of the incoming xrays and interactions with the detector, sometimes resulting in spectral artifacts. This is evident by the indication of tantalum (Ta), which should not be present given the feed material composition and materials used for processing.

An additional carbothermal reduction experimental series was conducted using silica-rich feeds instead of Mars or lunar soil simulant. These experiments were performed to evaluate results using feeds that are closer in composition to known silica-rich deposits on Mars. During the initial experiment, a stainless steel vacuum furnace tube was used instead of the mullite tubes used for earlier work. The vacuum furnace was constructed for the magnesium production experiments described in the next section but used for carbothermal reduction of silica sand to determine whether carbothermal reduction could be performed at low pressure and reduced temperature. Two additional experiments were conducted in the same type of mullite tube used for earlier carbothermal reduction experiments. Silica sand was used during the second experiment, and a silica-rich residue from previous work at Pioneer was used for the third experiment. The following table summarizes the experimental conditions and key results.

TABLE 5
Carbothermal Reduction Experiment Summary - Silica-Rich Feed.

| Test Parameter | Silica-01 | Silica-02 | Silica-03 |
|---|---|---|---|
| Feed Type | <70 Mesh | <70 Mesh | SiO₂-Rich |
| | Silica | Silica | Residue from |
| | | | JSC Mars-1 |
| | | | Aqueous |
| | | | Extraction |
| Reduction Temperature, ° C. | 1250 | 1650 | 1650 |
| Pressure, millibar absolute | ~1 | ~840 | ~840 |
| Hold Time at Temperature, | 4.25 | 3.25 | ~0.5 |
| hours | | | |
| Carbon:Soil Mass Ratio | 0.4 | 0.4 | 0.4 |
| Carbon Conversion to CO, % | 5.4 | 35.6 | 47.9 |
| Si Metal Yield, % of Feed Soil | 6.4 | 19.4 | 31.0 |
| Mass | | | |
| Oxygen Yield, % of Feed Soil | 15.3 | 18.8 | 19.2 |
| Mass | | | |
| Fumed SiO Product Yield, | — | 0.6 | — |
| % of Feed Soil | | | |

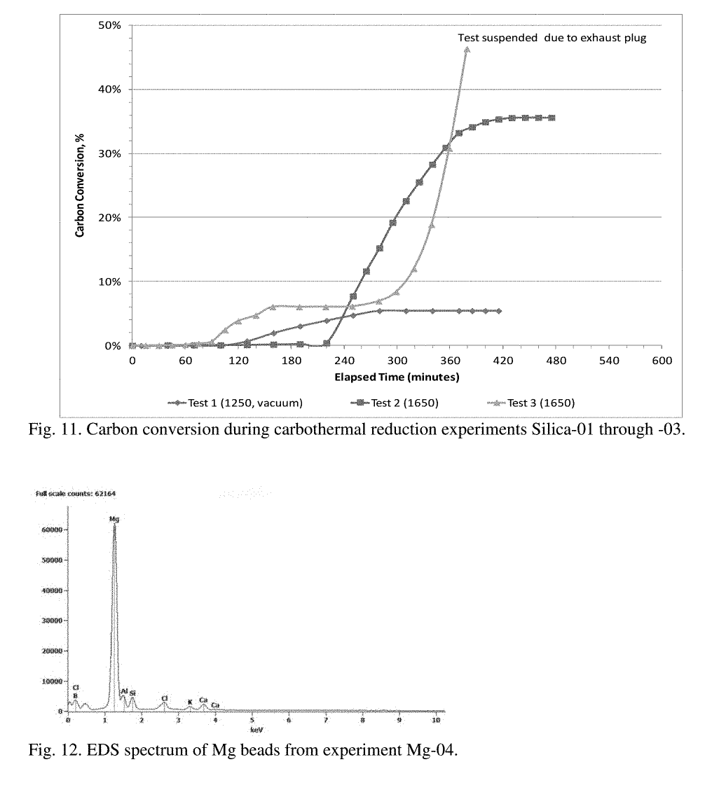

FIG. 11 shows the carbon conversion as a function of elapsed test time for each experiment. Additional details for each test are discussed next.

For the first experiment (Silica-01), <70 mesh (<0.21 mm) silica sand was mixed with graphite powder using a stoichiometric 0.4:1 C:SiO₂ weight ratio. The feed (about 28 grams total) was divided between two crucibles—one made of 316 stainless steel and the other of zirconium metal. The furnace was heated to 1250° and held for four hours at about 1 millibar absolute pressure (without sweep gas flow). Gas samples taken from the sealed, oil-free scroll pump exhaust showed carbon monoxide. However, only about 5 percent of the carbon reacted during the experiment. Results show that 1250° C. is not sufficient to carry out significant carbothermal reduction, even at low pressure. Crucibles did not exhibit any significant attack from the silica-carbon mixture.

The next experiment was carried out using the same type of silica sand (after baking at about 150° C. to remove traces of moisture) and the same stoichiometric 0.4:1 C:SiO₂ weight ratio. The feed was divided between three zirconium metal crucibles, which were used to evaluate the high-temperature performance of this material. The crucibles were placed in alumina dishes and then loaded into a horizontal mullite tube. This experiment was conducted at 1650° C. with a sweep gas flow rate of about 200 sccm helium and target hold time of four hours. However, after about 2.5 hours, the furnace tube exhaust began to plug, resulting in pressure build-up in the ceramic tube. As a result the experiment was suspended early.

The zirconium metal crucibles mostly held up to the 1650° C. operating conditions. However, each was distorted, and one was cracked resulting in a piece spalling off during testing. This result shows that zirconium metal is not a good candidate for repeated carbothermal reduction service.

A final experiment was conducted using 40 grams of silica-rich residue from aqueous extraction of JSC Mars-1 simulant obtained during Pioneer's work on the Mars Aqueous Processing System. This residue is the result of sulfuric acid extraction of much of the iron, aluminum, and magnesium present in the soil simulant. The composition of the residue is about 65 weight percent as SiO₂ with the balance consisting mostly of aluminum oxide (12 percent), calcium oxide (7 percent), iron oxide (6 percent), alkali metal oxides (about 3 percent), and small amounts of other constituents, including about 1.1 percent sulfur.

In addition to evaluation of the reactivity of the high-silica residue, further examination of crucible materials was performed. High-density graphite crucibles were fabricated in Pioneer's shop for these experiments. The crucibles were machined from a solid rod of graphite that was cut in half to make two half-round blocks. The blocks were then machined to accommodate the carbon and silica-rich feed. The crucibles just fit into the 2.375-inch (6.0 cm) inside diameter of the furnace tube. A stainless steel mesh was installed a short distance from the exhaust end plate to aid collection of fumed material from the furnace. The experiment was then carried out under protocols similar to those employed for previous experiments.

An issue with the furnace controller circuit breaker led to a shutdown after reaching about 1300° C. during heat up. The experiment was cooled under a flow of helium until repairs were made. Alternate circuit protection was used to permit continued operations. The test cycle was resumed, and the target temperature of 1650° C. was achieved and held for about 0.5 hour until plugging in the exhaust tubing led to another shutdown, again under a flow of helium. The blockage in the exhaust tube was cleared, and a larger-diameter stainless steel tube was installed to prevent further plugging. Upon restart, one of the ten molybendum disilicide heating elements failed (which prevented further operation), and the experiment was then terminated.

This experiment (Silica-03) achieved the full 1650° C. operating temperature and provided significant data with respect to silica reduction and crucible materials. Despite the short time at the target temperature, about 50 percent of the feed carbon was converted to CO. When the furnace tube exhaust end plate was removed, a significant amount of material that had vaporized from the reaction zone and condensed near the exhaust was noted. The material had the obvious odor of sulfur and may have also contained some fumed SiO based on the white color of some of the deposits.

About 0.25 percent of the silica-rich feed weight was recovered as the yellow and white deposit. This represents roughly one-fourth of the weight of contained sulfur based on the feed analysis. Additional deposits were recovered from the end plate, tubing, and other surfaces but a full accounting of the mass was difficult due to the sticky nature of the material.

Upon removing the test samples, it was found that the graphite crucibles were in excellent condition. The carbothermal reduction residue was removed from the graphite crucibles without much difficulty. Nearly complete recovery was obtained, and very little damage was noted. The crucible weights after removing residue were both within 0.1 percent of their initial weights. Both crucibles appeared to be capable of reuse. The test results indicate that the dense graphite material is not prone to reaction either with the silica-carbon feed blend or at the line of contact with the ceramic mullite tube.

### Experimental—Magnesium Production via Silicothermic Reduction

Salt deposits rich in magnesium have been identified in many locations on Mars. As reviewed in a 2006 journal article (Wang et al., 2006), compositional correlations of Mg and S in Mars surface materials were found during Viking, Pathfinder, Spirit, and Opportunity missions. Kieserite (MgSO₄.H₂O) was definitively identified from results of the Mars Express orbital mission. Other higher hydrates of magnesium sulfate may also be common near the surface of Mars (Wilson and Bish, 2012). The ready solubility of magnesium sulfate in water facilitates its selective recovery for use as a mineral resource.

In addition to more-readily available magnesium sulfates as described above, more-aggressive means can be employed to recovery magnesium from bulk Mars or lunar regolith. Typical regolith contains magnesium oxide concentrations in range of 7 to 10 percent, and Pioneer previously demonstrated methods to produce high purity MgO from such soils during the Mars Aqueous Process System (MAPS) Phase I and II programs (Berggren et al., 2007). High-purity MgO can be produced by calcining rich magnesium sulfate deposits on Mars for recovery magnesium oxide with simultaneous production of water, SO₂, and O₂, which can be used to produce sulfuric acid using a low-temperature liquid-phase catalytic method demonstrated previously during the MAPS program at Pioneer. The MgO recovered by this method is an excellent feed for reduction to metallic magnesium. Similar terrestrial minerals exist on Earth. In addition, magnesium oxide in the form of dolomite can supply the required magnesium oxide feed by calcining the dolomite to convert it from a carbonate mineral to an oxide mineral.

A potentially suitable process for manufacture of metallic magnesium from Mars resources was identified and evaluated.

Silicon metal or ferrosilicon generated by EMP carbothermal regolith reduction can be used as a reductant to produce metallic magnesium from MgO via the Pidgeon Process, which is typically carried out between 1200 and 1600° C. under vacuum (Simandl et al., 2007). Although silicothermic reduction is not as energy efficient as more recent electrolytic magnesium production processes, it requires the least-sophisticated hardware and is best suited for initial extraterrestrial application. Silicothermic reduction of magnesium oxide still supplies a majority of Earth's demand for magnesium. The silicothermic reaction to produce magnesium is as follows

Si+2 MgO=2Mg_{(g)}+SiO₂ ΔH=586.5 kJ (18)

The heat of reaction includes the additional endothermic heat of vaporization to produce Mg gas. Due to the low melting and boiling points of magnesium (650 and 1091° C., respectively), magnesium is vaporized from the furnace and is collected in a downstream condenser. As a result, the recovered magnesium can be of high quality.

Ferrosilicon is often used as a reductant in the Pidgeon process (the iron constituent remains in reduced form in this case; this approach enables the direct use of ferrosilicon generated by carbothermal reduction of Mars or lunar soils). The reaction above is not particularly favorable from a thermodynamic standpoint, but it is executed in a manner in which reaction products are removed and/or operation is carried out under vacuum to produce high yields of metallic product.

FIG. 6 illustrates an example magnesium metal production flow sheet and represents the general approach taken for the invention described herein. Similar processing can be carried out using other resources available on Mars, the Moon, asteroids, or Earth.

The high-temperature furnace described earlier was configured to carry out the initial reduction experiment of magnesium oxide using silicon metal to establish proof-of-concept. Samples were loaded into a Coorstek® mullite (aluminum silicate) furnace tube of about 42-inches (106.7-cm) length. Mullite was chosen for its high-temperature strength and thermal shock resistance. The cylindrical tube used for initial experiments was Coorstek item 66310 with an outside diameter of 1.50 inches (3.81 cm) and an inside diameter of 1.25 inches (3.18 cm). Later experiments were carried out in a similar Coorstek tube (item 66320) with an outside diameter of 1.625 inches (4.13 cm) and an inside diameter of 1.375 inches (3.49 cm). The open-ended tubes were fitted with endplates manufactured from stainless steel with a Viton® seal to provide a gas-tight fit. The total 42-inch tube length allows for gradual heating and cooling outside the 12-inch (30.5 cm) active hot zone, which is at the center of the tube. Insulation was added to reduce the temperature profile along the length of the tube outside the hot zone while still cooling the endplates to roughly 95° C.

A high-temperature thermocouple is located in the hot-zone of the furnace. In addition, thermocouples were placed at various locations along tube approaching the exhaust endplate. Temperature data were logged using a LabJack® U6-Pro interface and DAQFactory® data acquisition and control software on a laptop computer.

The endplates have fittings to allow for feeding and withdrawing gases. The feed gas line includes a gas flow meter and a manometer. The manometer allows for measurement of system pressure and also serves as a relief valve in the event of pressures above about 15-inches water column (about 37 millibar gauge pressure) since the tubes are not rated for pressure/vacuum operation at elevated temperatures. The exhaust gas line could be directed to a flow meter or sent directly to a vent.

A series of experiments was conducted to establish the viability of producing metallic magnesium from resources obtained from Mars or lunar soils and minerals. Because the standard ceramic tubes are not rated for operation under vacuum at high temperatures, a sweep of helium gas was used instead to aid removal of the magnesium metal reaction product as it formed. Reagent MgO powder (Aldrich 34,279; −325 mesh; 99+%) and Si metal powder (Sigma Aldrich 215619; −325 mesh; 99% metal) were used for these scouting experiments to demonstrate proof-of-concept.

An initial experiment (Mg-01) was carried out using a stoichiometric 2:1 MgO:Si molar ratio according to reaction equation (25) above. A total of 8.1 grams of feed was loaded into a 10 ml alumina reaction boat of about 90 mm length, 17 mm width, and 11.4 mm height (Coorstek item 65564) and placed in the mullite furnace tube at the center of the hot zone. A helium sweep gas of 100 standard cubic centimeters per minute (sccm) was applied throughout the experiment. The furnace was heated at a rate of 15° C. per minute up to 600° C. and then 10° C. per minute up to the final temperature of 1400° C., which was held for 2 hours. Upon cooling and removal of the crucible, some small, apparently metallic beads were observed in the crucible residue. In addition, about 0.03 gram of brown color residue was collected from a ring around the inside of the mullite furnace tube at about 13 inches (33 cm) from the endplate, or about 2 inches (5.1 cm) from the furnace hot zone. An additional 0.5 of a black deposit was collected from the inside surface of the mullite tube near the reaction crucible. A white deposit (presumably SiO) was noted on the inside surface of the exhaust endplate and on the thermocouple inserted through the endplate. The alumina reaction boat turned black, and it apparently absorbed about 1.5 grams of silicon. Results from the initial experiment Mg-01 indicated that a small amount of magnesium metal may have formed, but it did not vaporize and deposit downstream of the reaction boat. A second experiment was conducted at a target of about 200 sccm helium sweep gas to aid removal of vaporized magnesium from the reaction zone. In addition, stainless steel crucibles were used to prevent reaction of silicon metal with alumina (thus reducing its availability to react with magnesium oxide). Stainless steel is the standard material of choice in conventional Pidgeon process magnesium manufacture. The stainless steel crucibles were fabricated from a 304 stainless steel tube of 1 inch (2.54 cm) outside diameter and 0.035 inch (0.089 cm) wall thickness cut in half along its length. The half-round containers were cut to a length of about 5 inches (12.7 cm), and held about 20 ml of sample. The ends were left open for these experiments.

The feed for the second experiment (Mg-02) also consisted of a 2:1 stoichiometric ratio of MgO:Si. A total of 32.4 grams of feed was divided between two stainless steel crucibles. The same general procedures, heating rates, final temperature of 1400° C., and hold time of two hours were kept the same for second experiment. The pressure drop through the reactor system gradually increased as the experiment progressed. As a result, the helium sweep gas flow was gradually reduced to less than 50 sccm to maintain a pressure of less than about 5 inches water column (12.4 millibar).

After cool down, the furnace tube and residue were examined in a manner similar to that performed after experiment Mg-01. A shiny metallic material weighing 0.14 gram was collected from the mullite tube wall about 9 to 10 inches (22.9 to 25.4 cm) from the exhaust end plate. A white residue similar to that noted after experiment Mg-01 was found on the exhaust end plate, but it turned to a dark color upon exposure to air for about 30 minutes. The appearance of the residue from experiment Mg-02 was similar in appearance to that from the first experiment, with small nodules of apparent metallic material present in the residue. These nodules became very difficult to identify once the residue was transferred and blended.

The stainless steel sample boats did not appear to react significantly with the reactants or reaction products. However, only a small amount of magnesium metal appeared to have been made. A similar experiment was run (Mg-03) but with the addition of calcium oxide (Sigma Aldrich 12047; fine powder; extra pure). The calcium oxide was added in an attempt to prevent fuming of silicon oxide during silicothermic reduction. Literature indicates that addition of calcium oxide results in the formation of calcium silicate (Ca₂SiO₄) plus magnesium metal (Halmann et al., 2008). On Earth, this is accomplished using calcined dolomite (magnesium-calcium carbonate) rather than pure magnesium oxide as feed. For experiment Mg-03, calcium oxide (which is also available in Mars and lunar soil) was added in an amount of about 75 percent of the theoretical amount indicated by the following reaction shown at 1200° C.

Si+2MgO+2CaO=2Mg_{(g)}+Ca₂SiO₄ ΔH=457.3 kJ (19)

A total of 30.68 grams of feed was divided between two stainless steel reaction boats, and procedures similar to those for experiment Mg-02 were followed except that reaction time at 1400° C. was increased from two to three hours. In addition, a stainless steel mesh and alumina felt filter were added to increase surface area for condensation of metal. Except for an overall darker appearance of the residue, results similar to those reported above were obtained. The next experiment (Mg-04) was run in a similar manner, except the feed ingredients were proportioned in the stoichiometric amounts shown in reaction equation (26) above, and the reaction temperature was raised to 1450° C. In addition, an in-line flow meter that partially plugged and resulted in high system pressures was removed (a bubble meter was used to periodically check exhaust gas flows instead.) A helium sweep gas rate of 250 sccm was also used to more-rapidly remove vaporized reaction products from the reaction zone. This experiment produced a significant amount of metallic magnesium. Most of the magnesium product (1.02 grams of the total 1.63 total grams) was collected on the upstream edge of a length of perforated stainless steel that was used to provide surface area for the condensing metal. The “crown magnesium” formed as spherules at a distance of about 7 to 8 inches (17.8 to 20.3 cm) from the reactor tube endplate and were removed and recovered from the stainless steel traps without remelting but rather by careful prying. Additional gray residue (about 0.6 gram) was collected from the inside diameter of the mullite reaction tube at a distance of 3 to 4 inches (7.6 to 10.2 cm) from the endplate. The stainless steel reaction boats were severely attacked under the conditions of experiment Mg-04. The mullite furnace tube also broke during cool down. The mullite appeared to have been infused with a dark material through a distance of about one-half of the tube wall in the hot zone area of the furnace. Despite the operational difficulties of this experiment, magnesium in an amount of about 25 percent of the theoretical yield was recovered. FIG. 12 shows the EDS spectrum of the magnesium product.

The higher 1450° C. temperature was obviously too high for the stainless steel reaction crucibles. New crucibles were fabricated, and an additional experiment was carried out using the same feed formulation as that used for Mg-04 but at a temperature of 1400° C. with the same higher helium sweep gas rate. A furnace temperature controller fault caused an interruption in the test cycle, and results were therefore inconclusive.

Another experiment (Mg-06) was carried out using the same arrangement as described above at 1400° C. but using silicon as the reductant in one crucible and ferrosilicon as the reductant in the other crucible. A crack in the furnace tube allowed air into the reaction zone, resulting in no reaction.

Based on results so far, a stainless steel vacuum reaction tube (retort) was fabricated to enable experiments to be carried out under vacuum. The reactor chamber was fabricated from a 2-foot (61.0-cm) long 2-inch schedule 10 steel pipe that was welded on one end. The other end was fitted with a sanitary flange and Teflon® gasket to allow for vacuum operations. An exhaust tube with a manifold for inert gas purging, pressure transducer, block valve, and connection to the vacuum pump inlet was attached to a reducer fitted to the flange. A Varian IDP-3 dry scroll pump was used to evacuate the reactor to pressures as low as about 0.5 millibar absolute. The reactor was designed to allow the closed end of the tube to be supported in one end of the high-temperature furnace with the flange end extending about 8 inches (20.3 cm) out from the furnace. A small portion of the tube closest to the furnace was insulated to help seal the furnace chamber, and the remainder was left bare to allow cooling and condensing of vaporized magnesium product. All remaining experiments were carried out using magnesium oxide feed with silicon reductant and in some cases ferrosilicon reductant. No CaO was added to the feed mixture during later experiments. The feeds were thoroughly blended and then compressed to form either irregular pellets or cylindrical pellets.

The initial experiment in the stainless steel vacuum retort (experiment Mg-07) was carried out at 1200° C. at a pressure of about 1 millibar. A stainless steel product collection mesh was installed in the cooling section of the reactor to provide additional surface area for magnesium collection. Although the magnesium yield was low at about 12 percent, results were encouraging.

The next experiment (Mg-08) was carried out at 1250° C. using one feed crucible each with silicon metal and ferrosilicon reductant. About 50 grams of MgO were fed to this experiment. As temperatures between about 250 and 1150° C. during heat up, the reactor pressure stayed in the 5 millibar range, indicating some gas release from the feed. However, the pressure dropped to about 1 millibar as the reactor approached the target temperature. The reactor was held at temperature for seven hours before cooling. During cooling, helium was introduced to the system to equilibrate to atmospheric pressure for final cooling overnight.

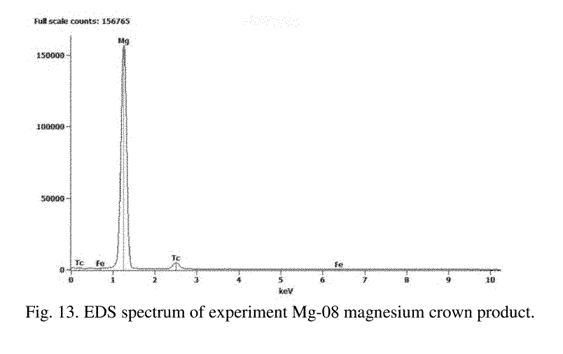

FIG. 13 shows the EDS spectrum for the magnesium crown recovered from experiment Mg-08. The analysis indicates very high-purity magnesium (with only an apparent “escape peak” resulting in a slight Tc peak).

During the course of the seven hour hold time, magnesium yield of about 37 percent of theoretical was obtained (based on the magnesium metal recovered from the reactor wall and collection mesh surfaces upon conclusion of the experiment). Feed and residue weights indicate about 51 percent magnesium yield, with unaccounted material likely attached to the collection mesh. In practice, the condenser would be heated to melt and drain magnesium metal for further processing.

The results from experiment Mg-08 showed the importance of temperature, with 1250° producing significantly better results than those at 1200° C. Higher temperatures were not used under vacuum due to limitations on the materials of construction for high temperature vacuum operation.

The next experiment (Mg-09) was conducted as a follow up to the previous experiment. Contamination on the scroll pump sealing surfaces resulted in pressures of 10 to 15 millibar. Upon examination after testing, it was found that very little reaction took place. This result showed the importance of low pressure to promote vaporization and transport of magnesium metal away from the reactants.

A final experiment (Mg-10) was carried out using feed consisting of compressed pellets of MgO (57.5 g) and Si (44.0 g) divided between two stainless steel crucibles. Conditions similar to those from experiment Mg-08 were used, except the hold time was slightly shorter (6.5 hours). To aid recovery of the magnesium product, no collection mesh was used; instead, the reactor surfaces were relied on to condense the vaporized magnesium. Results similar to those of experiment Mg-08 were obtained—a yield of about 35 percent of the theoretical magnesium was obtained (not including any product that couldn't be recovered from the reactor walls and stainless steel mesh collection surfaces. Based on the weight loss during reduction, the magnesium yield was about 42 percent.

The weight loss for the thinner disks during experiment Mg-10 was 21.9 percent versus 25.8 percent for the thicker pellets. Both types of feed were prepared in a hydraulic press in steel dies. Although the surface area of the thinner disks was higher, the thicker pellets may have resulted in better particle-particle contact, which is important for the solid phase reaction required to produce magnesium metal under these conditions. Despite the vaporization and transport of magnesium metal from the pellets and the relatively large weight loss, the residue pellets showed only some slight additional surface cracks and remained intact.

The magnesium product was similar to that obtained during Mg-08. The material appears to have characteristics typical of magnesium used on Earth to perform casting and additive manufacturing.

The overall results of the vacuum reduction of magnesium oxide with silicon were very encouraging. Process conditions were not optimized. Future work would be directed toward finding the best conditions of time, temperature, pressure, MgO:Si ratio, catalyst or flux addition, feed compression and pellet size, and condenser configuration. This technology is very promising for Mars applications given the preferred low pressure operation of the reaction, resources availability, and utility of the magnesium product for structural and other applications. A key element of the present invention is that the resulting silica-containing byproduct can be recycled to carbothermal reduction to regenerate the silicon metal used for reduction of magnesium.

### Experimental—Magnesium Production via Carbothermal Reduction

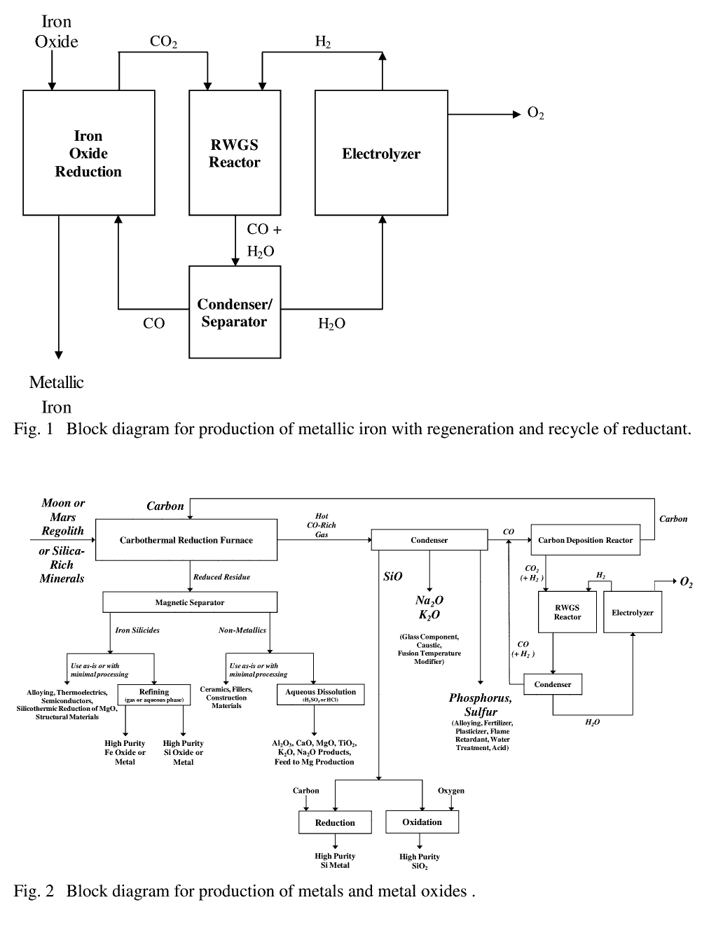

The following experiment illustrates the production of magnesium metal via carbothermal reduction under conditions that prevent the back-reaction of magnesium metal with carbon monoxide (which results in formation of magnesium oxide and carbon). A mixture of magnesium oxide (prepared by calcination of sulfate, carbonate, and other mineral forms) is mixed with carbon. The carbon is prepared using methods similar to those illustrated in FIG. 2 and FIG. 4 and is mixed with magnesium oxide in the approximate stoichiometric requirement to remove oxygen from MgO to form CO. The MgO/C mixture is loaded into a reactor such as that illustrated in FIG. 3. The reactor is evacuated to a pressure less than 1 millibar. Heat is applied to the reactor while maintaining a pressure of less than 1 millibar. At temperatures in excess of about 800 C, the magnesium oxide reacts with the carbon to produce magnesium metal vapor and carbon monoxide. The hot vapors are passed through a radio frequency coil that is supplied with sufficient current to ionize the magnesium metal vapors. Just downstream of the radio frequency coil, the carbon monoxide is pulled to a port on one side of the reactor that is connected to a vacuum pump. Simultaneously, the ionized magnesium metal vapors are pulled to a port on the opposite side of the reactor under the influence of a magnetic field, as illustrated in FIG. 3. The ionized vapors are attracted to a grounded, cooled metal plate, where magnesium metal condenses for collection as nearly pure product. Carbon monoxide collected from the reactor is fed to a carbon deposition reactor, which in conjunction with a reverse water gas shift reactor system, produces carbon required to reduce more magnesium oxide. In this manner, carbon remains within a closed loop, thereby drastically reducing or eliminating carbon emissions to the atmosphere.

### Additive Manufacturing Using EMP Products

In one embodiment, the products of the process are used in conventional casting and powder metallurgy hardware to produce useful parts. In one embodiment, the products of the process are used in Additive Manufacturing in forms such as liquid, filament/paste, powder and solid sheet. The first three categories each have multiple methods, though the filament/paste and powder categories have the techniques most applicable to in-space manufacturing. Fused Deposition Modeling (FDM), robocasting and Freeze-form Extrusion Fabrication (FEF) extrude thermoplastic or ceramic filaments or pastes. Selective Laser Sintering (SLS), Selective Laser Melting (SLM), Selective Separation Sintering (SSS), Electron-Beam Melting (EBM), Laser Metal Deposition (LMD) and 3D Printing (3DP) all use a polymer, metal or ceramic powder bed as building material, with the exception of LMD which injects a powder through a nozzle.

The process end products have been broadly categorized into metals, ceramics, electronics and glass, based on what they can be used to make via AM processes. Each category contains only those end products of a high enough quantity to be useful for AM. There may be some overlap between the metals, ceramics and electronics materials as their constituents may be suitable for manufacturing of multiple materials.

In other embodiments, the metal products of the process including the raw iron silicides (FeSi, Fe₃Si, FesSi₃, α-FeSi₂ and (3-FeSi₂) and pure iron. These products can be ground and sifted into fine powders (<100 microns) and used in the following AM processes as either a powder bed or part of an extruded paste: SLS, SLM, SSS, LMD, EBM, 3DP and FDM. While not all the referenced studies used iron as a feed material, they are still useful as general references to the use of metal powders in AM processes. Grain sizes of the metal powders varied from study to study, but were typically in the range of 1-100 microns. The impact of grain size is not understood at this time, though it may be assumed that smaller sizes allow for better sintering while larger grain sizes reduce the density of the manufactured material. Metal nanoparticle inkjet printing has also been developed by academia, but its use in low-gravity and vacuum environments has not been tested. The EMP metal end products can be used to make many functional parts in an in-space or extraterrestrial manufacturing facility. For example, the iron silicides could be used to make electrical steel, which can then be used to make electric motors and transformer cores.

A few methods exist for making metal powders, including grinding, atomization, and centrifugal disintegration. Pure iron has a hardness rating of 4 while ferrosilicon ranges from about 5-7, depending on the iron: silicon ratio. Various grinding wheels may need to be tested with the ferrosilicon beads created via EMP. Atomization of the metals can be performed with gas or water. Both forms involve forcing the molten metal through an orifice at high velocity and moderate pressure. With gas atomization, a gas is introduced into the metal stream before leaving the tube to create turbulence. Then the metal exits the orifice as a spray and is collected in a volume filled with gas. Gas and powder streams are separated by gravity or cyclonic methods. Water atomization involves intersecting the exiting molten metal with high-speed streams of atomized water. This cools the atomized metal faster and creates smaller, more homogenous particles. Atomization is not able to make particles smaller than 10 microns. One other method of powder creation is centrifugal disintegration, in which a rod of the desired metal is introduced into a chamber by a rapidly spinning spindle. An electrode opposite the spindle creates an electric arc which heats the metal rod. As the tip material fuses, the rod's rapid rotation throws off tiny melt droplets which solidify before hitting the chamber walls. Finally, a circulating gas sweeps the particles from the chamber.

Ceramic product SiC is the primary ceramic feed material available from the EMP as a byproduct, though other EMP end product trace compounds (such as alumina) may be mixed to form other ceramic substances. SiC may also be manufactured by combining SiO, SiO₂ and carbon via the Acheson process. However, this requires reaction times of about 20 hours at temperatures greater than 1600° C. A similar process using silica fume and high-energy ball milling is capable of producing nanometer SiC powders at slightly lower temperatures. AM processes available to this feed material include SLS, SSS, FDM, robocasting, FEF and 3DP. In a manner similar to metals, ceramic feed material can be in the form of either powder beds or extruded pastes. Ceramic powder grain sizes were more varied among the referenced articles, ranging from 9 to 250 microns, and no relationship is known between grain size and quality of the manufactured product.

Experiments successfully demonstrated the production of high quality (greater than 90 percent purity) ceramic oxide powders including alumina, magnesia, and calcia. In addition, high-silica process residues consisting of fine particles (containing up to about 75 percent contained silica) were also generated by MAPS. These materials may also have applicability to additive manufacturing either alone or in conjunction with other EMP products.

Electronics products of the process pure silicon is an end product available for use in AM manufacturing of electronic components, such as solar cells and semiconductors, inkjet and deposition technologies.

Glass products may be produced in one embodiment of the process. Potential EMP end products include SiO₂, Na₂O, CaO, Al₂O₃, K₂O, MgO, TiO₂ and Fe₂O₃, which can be combined to create soda-lime glass—the typical glass substance used to make containers and window panes. Compositions vary, but are typically 73-74 wt. % SiO₂ (silica), 13-14 wt. % Na₂O, 9-10.5 wt. % CaO (lime), 0.15-1.3 wt. % Al₂O₃, 0.03-0.3 wt. % K₂O, 0.2-4 wt. % MgO, 0.04-0.1 wt. % Fe₂O₃, and 0.01-0.02 wt. % TiO₂. (Some forms also contain a trace amounts of SO₃.)

Yet another glass manufacturing approach is based on recent research directed toward alumina-based glass. Alumina-based glass can be used to produce strong and optically desirable products. In some cases, modifiers such calcium and/or alkali-earth-element compounds are required for conventional formulations to reduce melting temperature and to improve thermal properties. Alumina glass composites can also be fabricated into molds where complex shapes with good dimensional control are possible.

Only one example could be found of glass used in an AM process, though it does show promise as a means for astronauts to replace parts (such as beakers) or manufacture windows for habitats.

### REFERENCES CITED

Berggren, Mark, Robert Zubrin, Cherie Wilson, Stacy Carrera, Anthony Muscatello, Heather Rose, and James Kilgore, “Mars Aqueous Processing System”, Pioneer Astronautics, NASA SBIR Phase II Final Report, NASA Contract NNJ05JA09C, Feb. 21, 2007.
Halmann, M., A. Frei, and A. Steinfeld, “Magnesium Production by the Pidgeon Process Involving Dolomite Calcination and MgO Silicothermic Reduction: Thermodynamic and Environmental Analysis”, Ind. Eng. Chem. Res., Volume 47, pp 2146-2154, 2008.
Simandl, George J., Hagen Schultes, Jana Simandl, and Suzanne Paradis, “Magnesium—Raw Materials, Metal Extraction and Economics—Global Picture”, Proceedings of the Ninth Biennial SGA Meeting, Dublin, 2007.
Squyres, S. W., R. E. Arvidson, S. Ruff, R. Gellert, R. V. Morris, D. W. Ming, L. Crumpler, J. D. Farmer, D. J. Des Marais, A. Yen, S. M. McLennan, W. Calvin, J. F. Bell III, B. C. Clark, A. Wang, T. J. McCoy, M. E. Schmidt, and P. A. de Souza Jr., “Detection of Silica-Rich Deposits on Mars”, Science, vol 320, May 23, 2008.
Wang, Alian, John J. Freeman, Bradley L. Jolliff, and I-ing Chou, “Sulfates on Mars: A systematic Raman spectroscopic study of hydration states of magnesium sulfates”, Geochimica et Cosmochimica Acta, Vol 70, Issue 24, 2006.
Wilson, Siobhan A. and David L. Bish, “Stability of Mg-sulphate minerals in the presence of smectites: Possible mineralogical controls on H₂O and nutrient cycling on Mars”, Australian Regolith and Clays Conference, Mildura, February 2012.

What is claimed is:

1. A process for the production of metallic iron comprising,
a) Preparation and regeneration of carbon monoxide reductant from carbon dioxide via the reverse water gas shift reaction,
b) Production of hydrogen for the reverse water gas shift reaction by water electrolysis,
c) Reduction of oxide minerals of iron by carbon monoxide, carbon, hydrogen, or methane to form said iron product.

2. A process of claim 1 where hydrogen for reduction is obtained by water electrolysis.

3. A process of claim 1 where carbon monoxide for reduction is obtained by the addition of a reverse water gas shift reactor (including a condenser, separation membrane, recycle compressor) to form carbon monoxide reductant and water electrolyzer to form hydrogen for conversion of carbon dioxide resulting from iron oxide reduction to carbon monoxide in the reverse water gas shift reactor with simultaneous production of oxygen byproduct.

4. A process of claim 1 where the majority of carbon monoxide reductant is supplied via reverse water gas shift and electrolysis to make a closed-loop system in which additional carbon monoxide is required only to make up for leaks and process losses.

5. A process of claim 1 where methane for reduction is obtained by methanation from synthesis gas and hydrogen from water electrolysis.

6. A process of claim 1 where carbothermal reduction of iron oxide uses products of a reverse water gas shift reaction, the Boudouard carbon deposition reaction, and water electrolysis.

7. A process of claim 1 where iron oxide is produced as sufficiently fine particles, subjected to reduction followed by sintering at temperatures below the melting point of iron.

8. A process of claim 1 where the iron-rich product can be melted and refined to transport impurities such as phosphorus, sulfur, and silicon to a slag phase while adjusting carbon content and alloying agent compositions of the iron melt.

9. A process for the production of silicon comprising,
a) Production of carbon reductant from carbon monoxide,
b) Reduction of silicon dioxide by carbon to form said silicon product, and;
c) Recovery of carbon monoxide from silicon dioxide reduction with subsequent regeneration of carbon reductant from carbon monoxide via the reverse water gas shift, Boudouard, and water electrolysis reactions.

10. A process of claim 9 where iron oxide is present in the feed and iron silicide is a product.

11. A process of claim 9 where carbon is obtained from a source including CO₂ in the Mars atmosphere, carbon from lunar soil, carbon imported from a remote location, carbon recovered from carbothermal reduction (as CO), from iron oxide reduction (as CO₂) or carbon deposited via the Boudouard reaction.

12. A process of claim 9 where silicon, ferrosilicon, and high purity fumed silicon monoxide are generated via carbothermal reduction.

13. A process for production of metallic magnesium comprising,
a) Carbothermal reduction of oxide minerals of silicon to form metallic silicon or ferrosilicon, and;
b) Reduction of magnesium by silicon.

14. A process of claim 13 where silicon or ferrosilicon produced by EMP is used as a reductant for production of high-purity magnesium or other light metals.

15. A process of claim 13 where silicon oxides contained in the silicothermic reduction products from magnesium oxide reduction are recycled and reacted with carbon to form silicon and ferrosilicon thus reducing the need for fresh silica-containing materials.

16. A process of claim 13 where carbon monoxide produced by carbothermal reduction of silica-containing materials is captured and subjected to carbon deposition via the Boudouard reaction in conjunction with reverse water gas shift-electrolysis modules, thus reducing the need for fresh carbon.

17. A process for production of metallic magnesium comprising,
a) Carbothermal reduction of magnesium-oxide-containing feeds in vacuum, and
b) Ionization of produced magnesium metal vapors, and
c) Separation of ionized magnesium metal vapors from carbon monoxide gas via a magnetic field, and
d) Collection of magnesium metal on a grounded, chilled plate with simultaneous collection of carbon monoxide via a vacuum pump.

18. A process of claim 17 where carbothermal reduction of magnesium is conducted at temperatures above 600 C and pressures below 1 millibar absolute

19. A process of claim 17 where magnesium metal vapors and carbon monoxide produced by carbothermal reduction are passed through a radio frequency coil supplied with sufficient current to generate the required minimum 7.65 eV to ionize magnesium.

20. A process of claim 17 where ionized magnesium metal vapors are directed by passing through a magnetic field downstream of the radio frequency coil.

21. A process of claim 17 where ionized magnesium metal vapors are collected on a chilled, grounded plate located in a position opposite that of the reactor gas outlet port.

22. A process of claim 17 where carbon monoxide gas is directed toward a vacuum pump port located opposite the magnesium metal collection plate.

23. A process of claim 17 where condensed magnesium metal in solid or liquid form is removed from the condensing plate.

24. A process of claim 17 where carbon monoxide collected from the carbothermal reduction of magnesium oxide is subjected to the Boudouard reaction to form carbon used for carbothermal reduction of more magnesium oxide containing feed.

25. A process of claim 17 where CO₂ produced in the Boudouard reactor is fed to a reverse water gas shift reactor system integrated with water electrolysis to produce CO for recycle to the Boudouard reactor.

26. A process of claim 17 where water produced in the reverse water gas shift reactor system is fed to an electrolyzer to generate hydrogen (which is fed to the RWGS reactor) and oxygen (which constitutes a product of the process).

27. A process of claim 17 comprising a closed-loop system in which magnesium oxide containing feed is converted to magnesium metal and oxygen byproduct through the use of integrated an carbothermal reactor, RWGS system, and electrolysis, resulting in very low emissions of carbon gases.
